(19) United States
(12) Patent Application Publication
(10) Pub. No.: US 2014/0069247 A1
(43) Pub. Date: Mar. 13, 2014

(54) SHEET MATERIAL CUTTER

(71) Applicants: Chuan-Sheng LIN, Taichung City (TW); Shih-Wei Lin, Taichung City (TW)

(72) Inventors: Chuan-Sheng LIN, Taichung City (TW); Shih-Wei Lin, Taichung City (TW)

(73) Assignee: Chuan-Sheng LIN

(21) Appl. No.: 13/610,862

(22) Filed: Sep. 12, 2012

(51) Int. Cl. B23D 19/06

(52) U.S. Cl. 83/162

(57) ABSTRACT

A cutter used for cutting sheet material includes a cutting board, a knife rack and two pairs of knife wheels. The cutting board allows the sheet material to be placed on and has a guiding track. The knife rack is arranged on the cutting board and is able to slide along with the guiding track. One inner side of the knife rack near the guiding track is provided with two pairs of knife grooves, and two guiding grooves are provided on the knife rack between the two pairs of knife grooves respectively, and the two guiding grooves are used to guide the cut sheet material to leave. The two knife wheels are installed inside the upper and lower pairs of knife grooves of the knife rack.

### BACKGROUND

1. Technical Field

The present invention relates to a cutter, particularly a cutter used for cutting sheet material and has high safety.

2. Related Art

Nowadays, the well-known cutter includes a cutting board and a knife body pivotally connected to one side of cutting board, and one edge of the cutting board forms a sharp edge. One knife blade of the knife body is closely neighboring to outer side of the sharp edge. When the user presses down the knife body to force the knife blade doing the back-and-forth cutting against the sharp edge, the sheet material which goes through the sharp edge will be cut off. Another conventional cutter uses knife wheels rolling back-and forth against the sharp edge to cut the sheet material. Since the knife wheels and the sharp edge should match each other, the side of the knife wheels which near the sharp edge should be uncovered and exposed to outside, thereby facilitating the user to precisely align the knife wheels to the sharp edge.

However, those cutters mentioned above are not safe enough. One side of the knife body or knife wheel should be uncovered and exposed to outside because the knife body or knife wheel should match the sharp edge of the cutting board for the cutting purpose, and thus the user can possibly get hurt when using the cutter.

### BRIEF SUMMARY

The present invention provides a cutter used for cutting sheet materials, and the cutter has great safety and stability.

The present invention provides a cutter used for cutting sheet materials, comprising:

a cutting board having a guiding track;
a knife rack arranged on the cutting board and being able to slide along the guiding track, one side of the knife rack that near the guiding track being provided with two knife grooves, a guiding groove defined between the two knife grooves and guiding the sheet material to leave after being cut; and
at least one pair of knife wheels installed inside the two knife grooves of the knife rack, the pair of knife wheels being tangent to each other and meeting at the guiding track.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is an assembling perspective view in accordance with the present invention;

FIG. 2 is a disassembling perspective view in accordance with the present invention;

FIG. 3 is another disassembling perspective view in accordance with the present invention;

FIG. 4 is a cross-section view of the knife wheel and the assembling thereof in accordance with the present invention;

FIG. 5 is a cross-section view of an idler and the assembling thereof in accordance with the present invention;

FIG. 6 is a cross-section view when operating the device in accordance with the present invention;

FIG. 7 is a schematic view of operating the cutter in a direction in accordance with the present invention; and

FIG. 8 is a schematic view of operating the cutter in an opposite direction in accordance with the present invention.

### DETAILED DESCRIPTION

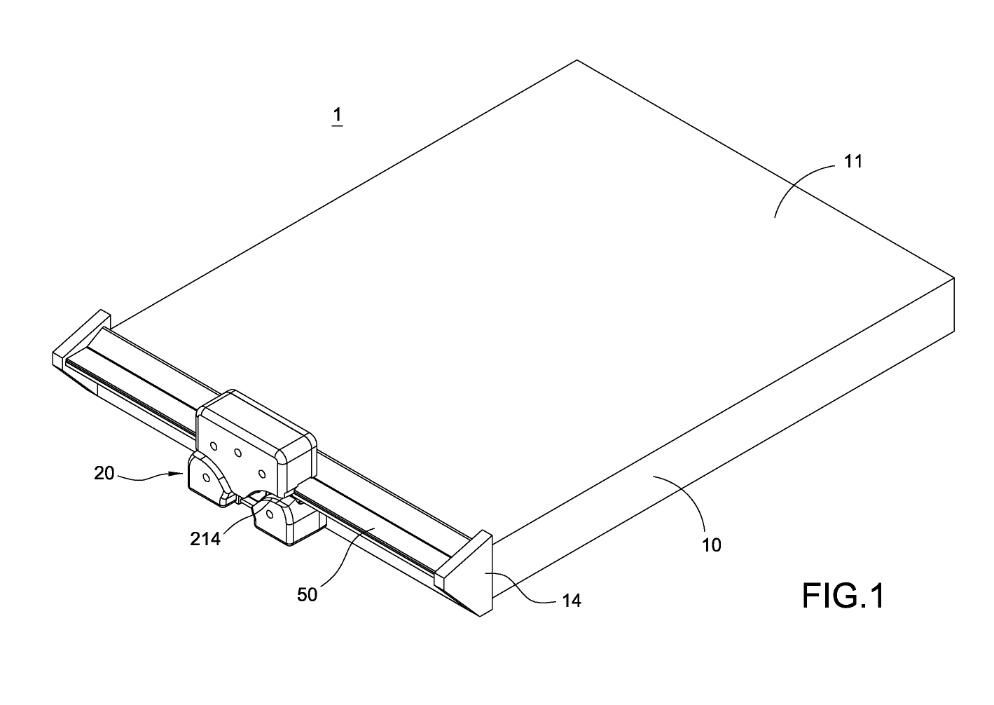

Please refer to FIGS. 1-5, a cutter 1 used for cutting sheet material comprises a cutting board 10, a knife rack 20, two pairs of knife wheels 30, and each pair of knife wheels 30 is composed of an upper knife wheel 31 and a lower knife wheel 32.

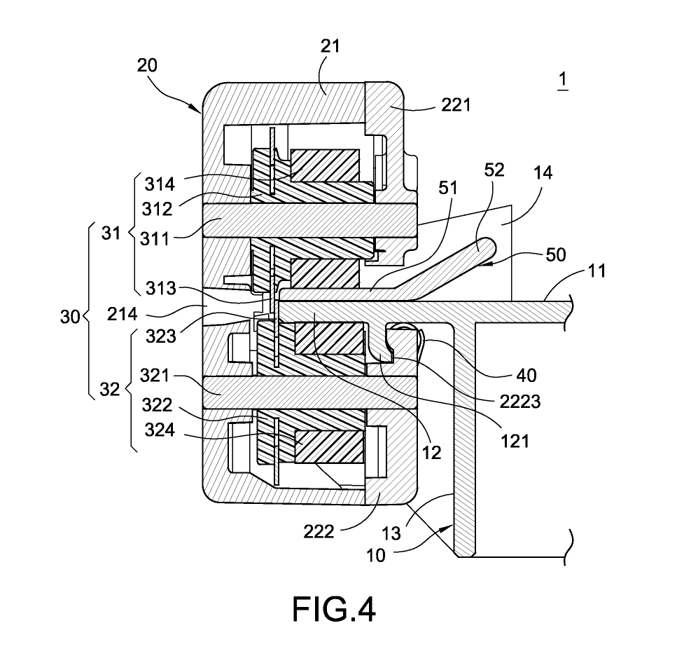

The cutting board 10 is approximately in a rectangle form and has a main surface 11, and a sheet material is placed on the main surface 11. Please see FIG. 4, the cutting board 10 has a guiding track 12 which is situated on the left edge side of the cutting board 10 and forms an upside down L shape structure with a vertical side surface 13 of the cutting board 10. The cutting board 10 is provided with a baffle 14 on both ends of the guiding track 12 to restrict the back-and-forth sliding distance of the knife rack 20. The width of the main surface 11 of the cutting board 10 can be adjusted on user's demand, and can also be designed to have small width for easy carry purpose.

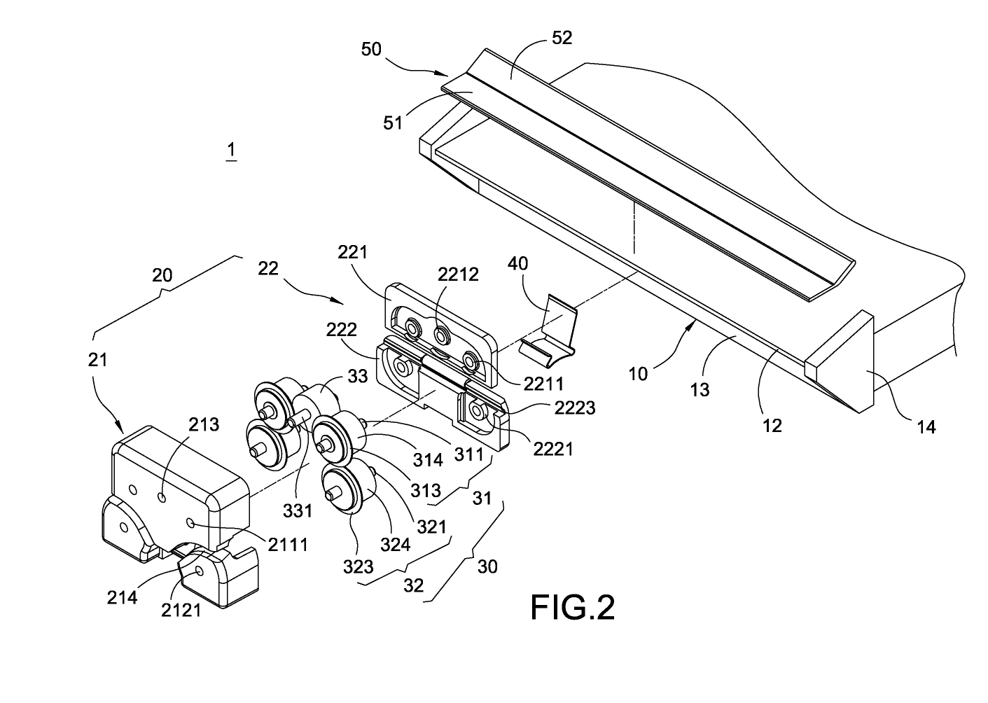

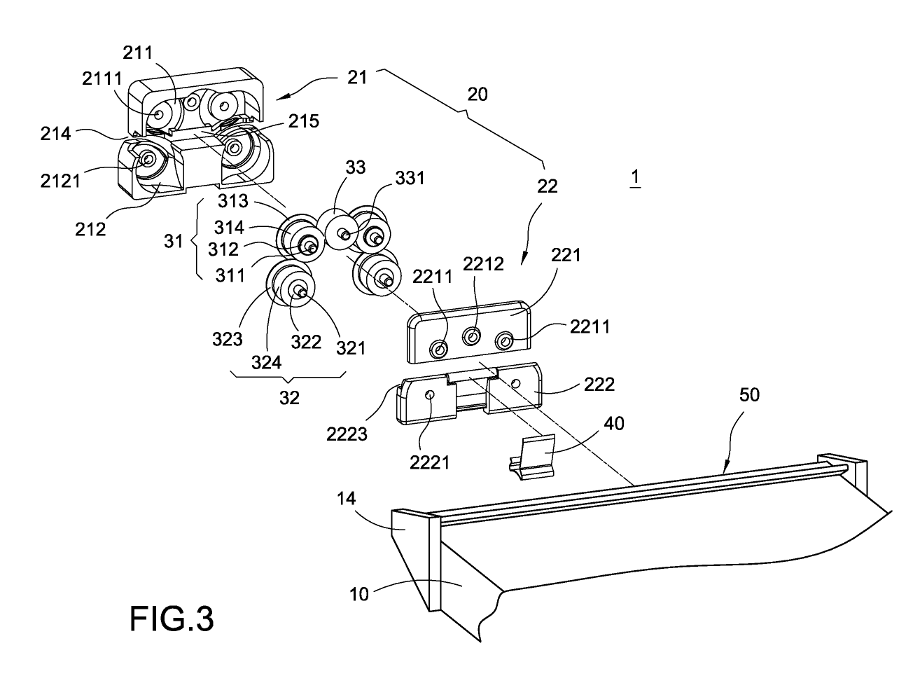

The knife rack 20 is arranged on the cutting board 10 and is able to slide along the guiding track 12. As shown in FIGS. 2 and 3, the knife rack 20 is composed of an outer case 21 and an inner case 22. The outer case 21 has an inner side facing toward the guiding track 12, and the inner side is provided with two upper knife grooves 211 and two lower knife grooves 212. Each upper knife groove 211 is corresponding to the near lower knife groove 212 which is arranged right underneath, thereby accommodating two pairs of knife wheels 30 respectively. The center of each upper knife wheel 211 is provided with an upper knife wheel axle hole 2111, and the center of each lower knife wheel 212 is provided with an lower knife wheel axle hole 2121. The upper knife wheel axle hole 2111 allows one end of the axles 311 to be inserted into the corresponding upper knife wheel 31, and the lower knife wheel axle hole 2121 allows one end of the axles 321 to be inserted into the corresponding lower knife wheel 32. An idler axle hole 213 is provided between two upper knife grooves 211 of the outer case 21, and the idler axle hole 213 is inserted with one end of the axle 331 of an idler 33. Besides, a guiding groove 214 which guides the exit for the sheet material 100 after being cut is provided on the outer case 21 between each pair of upper knife grooves 211 and lower knife grooves 212. The guiding groove 214 is approximately in an arc shape and guides the cut sheet material to hang down from the center bottom of the outer case 21. A connecting portion 215 is provided between two guiding grooves 214. The connecting portion 215 prevents the intercommunication of the two guiding grooves 214 and also keeps the integrity of the outer case 21. In other words, although the outer case 21 is provided with two upper knife grooves 211 and two lower knife grooves 212, the upper and lower parts of the outer case 21 can still keep connecting and move together because of the arrangement of the connecting portion 215. As a result, the relative position of the two pairs of upper knife grooves 211 and lower knife grooves 212 of the outer case 21 will not change with the sliding of the knife rack 20, thereby keeping the relative position of the two pairs of knife wheels 30.

The inner case 22 is composed of an upper case body 221 and a lower case body 222. The upper case body 221 and the lower case body 222 are separated components. The upper case body 221 arranged on the upper part of the outer case 21, and the lower case body 222 arranged on the lower part of the outer case 21. An interspace between the upper case body 221 and the lower case body 222 allows the sheet material 100 placed on the cutting board 10 to pass through therein and to be cut by the upper knife wheel 31 and the lower knife wheel 32 simultaneously. The upper case body 221 is provided with three axle holes. The right and left axle holes are two upper knife wheel axle holes 2111 that the two knife wheel axle holes 2211 correspond to the two upper knife grooves 211 of the upper portion of the outer case 21 respectively. The middle axle hole is idler axle hole 2212 which corresponds to the idler axle hole 213 of the outer case 21. The lower case body 222 has two lower knife wheel axle holes 2221 which correspond to the two lower knife wheel axle holes 2121 within the two lower knife grooves 212 of the lower portion of the outer case 21. By this arrangement, when the outer case 21 and the inner case 22 are assembled together, the two pairs of knife wheels 30 and the idler 33 can be together sandwiched between the outer case 21 and the inner case 22.

Besides, near the upper edge of the lower case body 222 of the inner case 22 is provided with a slot 2223, and the lower surface of the guiding track 12 of the cutting board 10 is correspondingly formed a hooking arm 121 which engages with the slot 2223, thereby enabling the whole knife rack 20 to be installed on the guiding track 12 of the cutting board 10 and sliding along the guiding track 12.

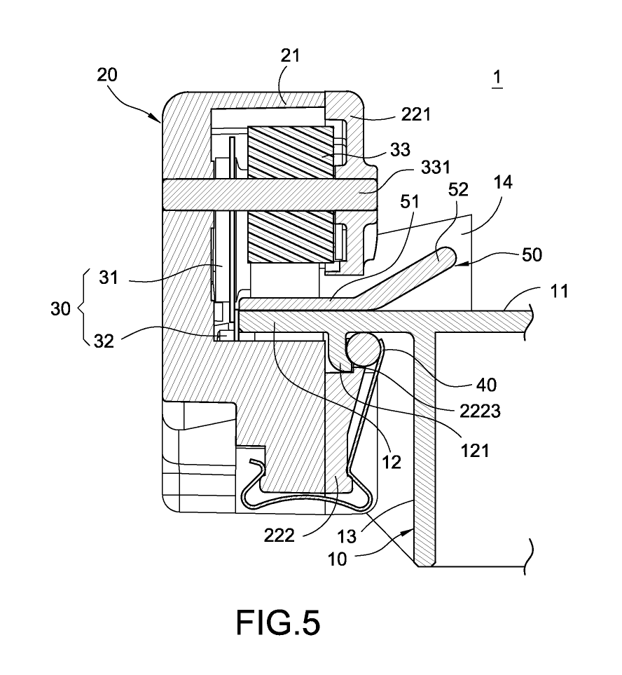

A leaf spring 40 is provided in order to increase the matching of the knife rack 20 and the cutting board 10. As shown in FIG. 5, the leaf spring 40 is bent to correspond to the outline of the lower case body 222 of the inner case 22. The width of the leaf spring 40 is broad enough to increase the area for exertion. One end of the leaf spring 40 presses the outer surface of the position where the lower case body 222 engages with the hooking arm 121, thereby strengthening the engaging compactness between the hooking arm 121 and the slot 2223. The other end of the leaf spring 40 presses the lower edge of the outer case 21 to force the outer case toward the cutting board 10, and thus the knife rack 20 can face toward the cutting board 10 without detachment.

Every upper knife wheel includes an axle 311, a wheel body 312 which allows the axle 311 to penetrate therein, and a knife blade provided on the outer surface of the wheel body 312. The axle 311 can rotate between the upper knife wheel axle holes 2111 and 2211. However, in order to smoothen the rotation of the upper knife wheel 31, a bearing (not shown) can be installed on both ends of the axle 311, respectively, or an inner bearing is provided between the axle 311 and the wheel body 312, which makes the wheel body 312 rotate relative to the axle 311. When the axle 31 or the wheel body 312 rotates, the knife blade 313 installed on the outer surface of the wheel body 312 rotates as well. Similarly, the lower knife wheel 32 includes an axle 321. As shown in FIG. 4, the side edge of the knife blade 313 of the upper knife wheel 31 aligns the side edge of the knife blade 323 of the lower knife wheel 32, and both knife blades 313, 323 meet at the guiding track 12 of the cutting board 10. By this arrangement, the knife blades 313, 323 can be tangent to each other, but not wearing down easily.

Between two pairs of the knife wheels 30, especially the two upper knife wheels 31, the idler 33 is provided. The outer surface of the idler 33 and the outer surfaces of the two upper knife wheels 31 are formed rolling engagement. As a result, the rotation of any one of the upper knife wheel 31 can drive the idler 33 simultaneously, and further drives another upper knife wheel 31 to rotate to facilitate the bi-direction cutting, as well as effort-saving.

Please see FIG. 4, the guiding groove 214 is provided between the upper knife groove 211 and the lower knife groove 212 of the outer case 21. Specifically, the guiding groove 214 is arranged at the downstream side of the incision of the knife blade 313 of the upper knife wheel 31 and the knife blade 323 of the lower knife wheel 32. Thus, the knife blade 313 of the upper knife wheel 31 and the knife blade 323 of the lower knife wheel 32 are installed inside the knife rack 20 respectively, without exposure to the outside. Therefore, user's finger or skin is impossible to touch the knife blade 313 or 323, which increases the safety when using the cutter.

Besides, the guiding groove 214 goes through the outer side surface of the knife rack 20 (i.e. the outer side surface of the outer case 21) to be in an open condition. If the guiding groove 214 does not go through the outer side surface of the knife rack 20, the width of the cut sheet material (waste portion) will be restricted to the width of the guiding groove 214. Since the guiding groove 214 goes through the outer side surface of the knife rack 20, the width of the cut sheet material (waste portion) is not limited.

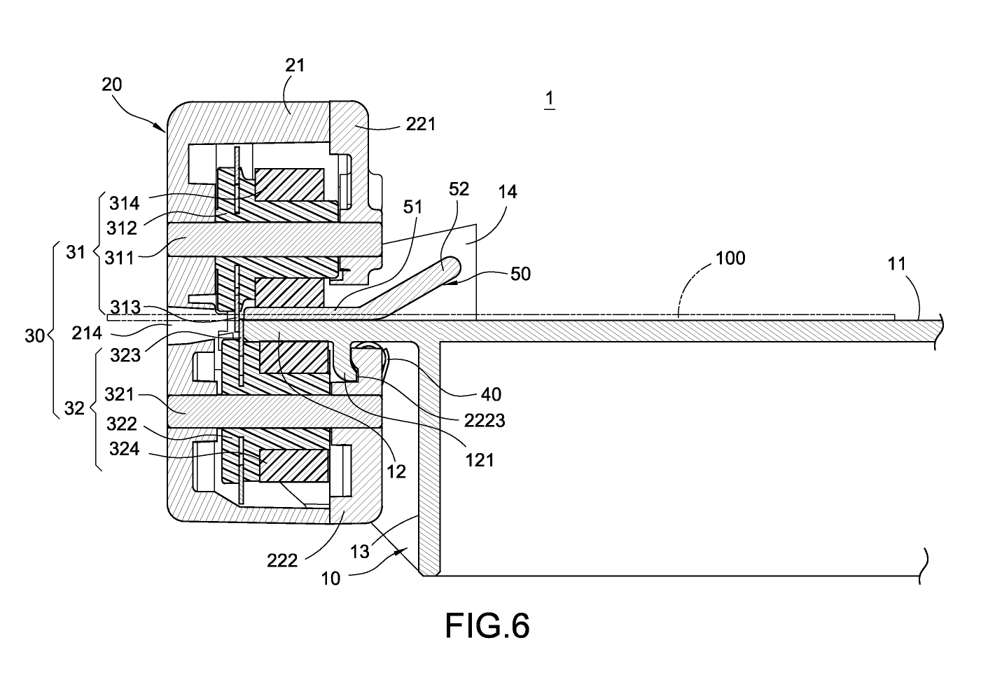

In order to flatten the sheet material 100 placed on the cutting board 10 without tilting or curving as the sheet material 100 passes through the interspace between the upper case body 221 and the lower case body 222 to enter the knife rack 20 for cutting, a platen 50 is provided on the main surface 11 of the cutting board 10 of the cutter 1. The platen 50 includes a pressing portion 51 and a guiding portion 52 curved and extended from the pressing portion 51. The pressing portion 51 is appressed to the main surface 11 of the cutting board 10 and one edge of the pressing portion 51 is aligned to the outer edge of the guiding track 12. The guiding portion 52 is more away from the guiding track 12 than the pressing portion 51, and the guiding portion 52 is bent upward to form an inclined plane relative to the main surface 11 of the cutting board 10. As shown in FIG. 6, the inclined plane is used to guide the sheet material 100 to enter the space between the pressing portion 51 and the cutting board 10 for preparing the cutting process.

In order to drive the upper knife wheel 31 and the lower knife wheel 32 to rotate simultaneously, as shown in FIG. 4, an outer ring body 314 is provided on the outer surface of the wheel body 312 of the upper knife wheel 31. The outer surface of the outer ring body 314 is aligned to the upper surface of the pressing portion 51 of the platen 50. The outer surface of the wheel body 322 of the lower knife wheel 32 is also provided with an outer ring body 324. The outer surface of the outer ring body 324 is aligned to the lower surface of the guiding track 12. By doing so, when the knife rack 20 slides along the guiding track 12, the outer ring 314 of the upper knife wheel 31 can roll on the pressing portion 51 of the platen 50, thereby driving the upper knife wheel 31 to rotate. Meanwhile, the outer ring body 324 of the lower knife wheel 32 rolls on the lower surface of the guiding track 12, thereby driving the lower knife wheel 32 to rotate. As such, the upper knife wheel 31 and the lower wheel 32 can rotate simultaneously to do the cutting. Besides, the outer ring body 314 of the upper knife wheel 31 and the outer ring body 324 of the lower knife wheel 32 can increase the cutting stability of the upper knife wheel 31 and the lower knife wheel 32, respectively. However, the outer diameter of the idler 33 will decrease to maintain the rolling engagement for the two upper knife wheels 31 after installing the outer ring body 314 and 324. On the other hand, installing the outer ring body 314 and 324 can take advantage of the friction to drive the upper knife wheel 31 and the lower knife wheel 32 to generate larger rotational torque, which saves some effort for the user.

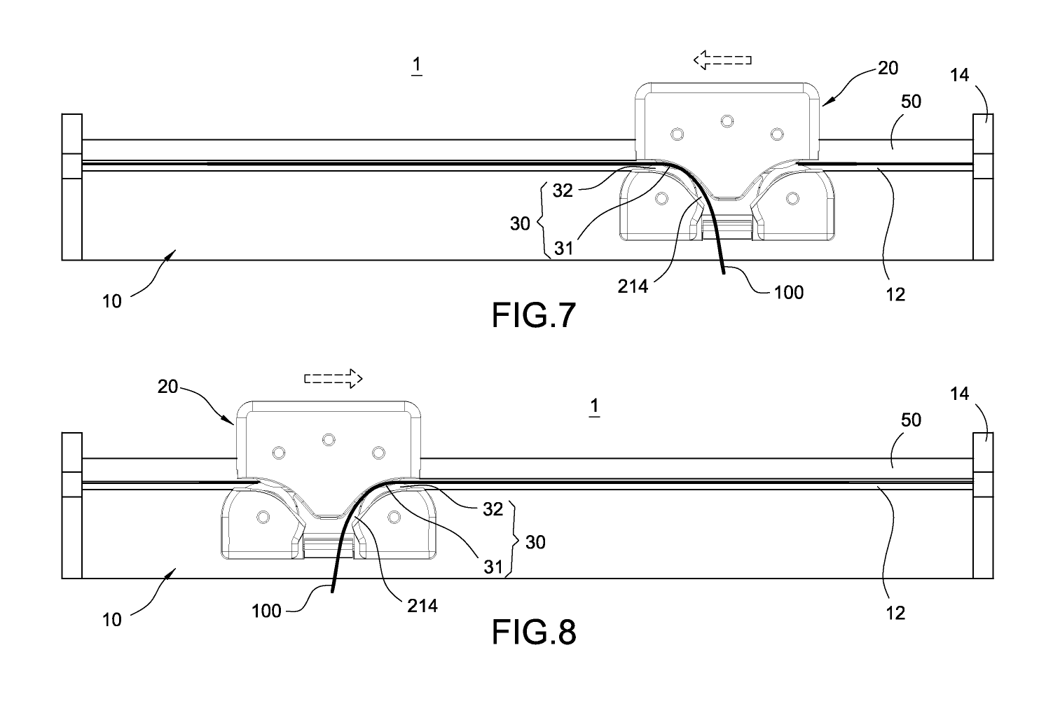

Please refer to FIG. 7, when the knife rack 20 cuts the sheet material 100 along the guiding track 12 of the cutting board 10 by the arrow direction which goes from right to left, the pair of upper knife wheel 31 and the lower knife wheel 32 of the protruding edge which receives the sheet material 100 is cutting the sheet material. The cut sheet material will cast down from the center bottom of the knife rack 20 along the arc shape outline of the guiding groove 214 on the left hand side. Meanwhile, a pair of knife wheels on the right hand side does not do the cutting task, but still rotates simultaneously by the driving of the idler (not shown). Similarly, please refer to FIG. 8, when the knife rack 20 cuts the sheet material 100 along the guiding track 12 of the cutting board 10 by the arrow direction which goes from left to right, the a pair of upper knife wheel 31 and the lower knife wheel 32 of the protruding edge which receives the sheet material 100 is cutting the sheet material. The cut sheet material will cast down from the center bottom of the knife rack 20 along the arc shape outline of the guiding groove 214 on the right hand side. Meanwhile, a pair of knife wheels on the left hand side does not do the cutting task, but still rotates simultaneously by the driving of the idler (not shown).

Please refer to FIGS. 7 and 8, the advantage of installing two pairs of knife wheels 30 lies in that: when the knife rack 20 slides along the guiding track 12 of the cutting board 10, no matter in any place during the sliding route, there will be an upper knife wheel 31 and a lower knife wheel 32 of one of the pair of knife wheels 30 doing the cutting. Thus, the user will not waste any one of the sliding motion of the knife rack 20, thereby increasing the cutting efficiency of the cutter 1. Moreover, even if the other pair of knife wheels 30 does not do the cutting, they can also rotate along with the working pair of knife wheels 30 to keep the aligned upper knife wheel 31 and lower knife wheel 32 abrasive to each other, thereby maintaining the knife wheels in sharp condition.

Since the upper knife wheel 31 and lower knife wheel 32 of the knife wheel 30 are arranged in tangent form, even if only installing a pair of knife wheels 30, parts of the knife blades of the pair knife wheels 30 which are near the sheet material 100 will be close to each other to do the cutting when the knife wheel 30 cuts the sheet material 100 in a specific direction. Even though parts of the knife blades which are away form the sheet material 100 do not cut the sheet material 100, the knife blades of the upper knife wheel 31 and the lower knife wheel 32 can be abrasive to each other, thereby keeping the knife blade sharp without damaging the knife blade.

Although the present invention has been described with reference to the foregoing preferred embodiments, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. A cutter used for cutting sheet material, comprising:
a cutting board having a guiding track;
a knife rack arranged on the cutting board and being able to slide along the guiding track, one side of the knife rack that near the guiding track being provided with two knife grooves;
a guiding groove defined between the two knife grooves and guiding the sheet material to leave after being cut; and
at least one pair of knife wheels installed inside the two knife grooves of the knife rack, the pair of knife wheels being tangent to each other and meeting at the guiding track.

2. The cutter according to claim 1, wherein each knife wheel comprises an upper knife wheel and a lower knife wheel, the upper knife wheel and the lower knife wheel are tangent to each other, and the knife rack comprises an outer case and an inner case near the guiding track and being connected with the outer case, and the pair of the knife wheels is positioned between the outer case and the inner case.

3. The cutter according to claim 2, wherein the two knife grooves are provided on one inner side of the outer case and comprise an upper knife groove and a lower knife groove, and the upper knife groove and the lower knife groove are used to accommodate the upper knife wheel and the lower knife wheel respectively.

4. The cutter according to claim 3 further comprising another pair of knife wheels and an idler, and the idler providing rolling engagement between the two upper knife wheels of the two pairs of the knife wheels.

5. The cutter according to claim 4 further comprising another two knife grooves, and the four knife grooves being provided to the inner side of the outer case and comprising two upper knife grooves and two lower knife grooves, and the two upper knife grooves and the two lower knife grooves being used to accommodating the two upper knife wheels and two lower knife wheels of the two pairs of the knife wheels.

6. The cutter according to claim 5, wherein another guiding groove is defined between the another two knife grooves, and the two guiding grooves face toward the outer surface of the outer case and are in an open form, and a connecting portion is provided on the outer case between the two guiding grooves to connect the outer case.

7. The cutter according to claim 6, wherein the inner case comprises an upper case body and a lower case body, the upper case body is assembled to an upper portion of the outer case, the lower case body is assembled to a lower portion of the outer case, and an interspace between the upper case body and the lower case body allows the sheet material on the cutting board to pass through and cut by at least one pair of the knife wheels.

8. The cutter according to claim 7, wherein a slot is provided near the upper edge of the lower case body, a lower surface of the guiding track of the cutting board is formed with a hooking arm corresponding and engaging to the slot.

9. The cutter according to claim 8, wherein a leaf spring is provided between the knife rack and the cutting board, one end of the leaf spring presses the outer surface of the lower case body to engage with the hooking arm, and the other end of the leaf spring presses the outer case to force the outer case facing toward the cutting board.

10. The cutter according to claim 9, wherein each of the upper knife wheel and the lower knife wheel has an axle, a wheel body to be inserted with the axle, and a knife blade arranged to the outer surface of the wheel body, the knife blade of the upper knife wheel and the knife blade of the lower knife wheel do the cutting with their side edges being aligned to each other, and the upper knife wheel and the lower knife wheel can rotate and do the cutting inside the knife rack.

11. The cutter according to claim 10, wherein the upper knife wheel and the lower knife wheel are installed between the outer case and the inner case with a bearing.

12. The cutter according to claim 10 further comprising a platen, wherein the platen is arranged on the cutting board and includes a pressing portion and a guiding portion bending and extending from the pressing portion, the pressing portion is appressed to the upper surface of the cutting board and the edge of the pressing portion is aligned to the guiding track, and the guiding portion extends away from the guiding track and bends upward relative to the upper surface of the cutting board.

13. The cutter according to claim 12, wherein an outer ring body is provided on the outer surface of the wheel body of the upper knife wheel, the outer ring body is appressed to the upper surface of the pressing portion, an outer ring body is provided on the outer surface of the wheel body of the lower knife wheel, and the outer ring body is appressed to the lower surface of the guiding track, and the idler rolls and engages between the two outer ring bodies of the two upper knife wheels.

14. The cutter according to claim 13, wherein the cutting board is provided with a baffle at two ends of the guiding track respectively.
